(19) United States
(12) Patent Application Publication
(10) Pub. No.: US 2023/0262301 A1
(43) Pub. Date: Aug. 17, 2023

(54) Motion Sensor Control of Trail Cameras

(71) Applicant: Steven Dwight Thomas, JR., Spokane, WA (US)

(72) Inventor: Steven Dwight Thomas, JR., Spokane, WA (US)

(21) Appl. No.: 18/105,852

(22) Filed: Feb. 5, 2023

Related U.S. Application Data
(60) Provisional application No. 63/309,574, filed on Feb. 13, 2022.

(51) Int. Cl. H04N 23/45; H04N 23/661; H04N 23/667; A01M 31/00

(52) U.S. Cl. CPC H04N 23/45; H04N 23/662; H04N 23/667; A01M 31/002

(57) ABSTRACT

The disclosed implementations offer techniques for using different motion sensitivity settings for a trail camera to flexibly control how the trail camera captures images. For instance, a trail camera can be provided with multiple motion sensors configurable to different sensitivities, and can have different image capture settings depending on which motion sensor triggers. In other implementations, a single motion sensor can output a magnitude of a detection signal to similarly control image capture settings.

### I. PRIORITY

This application claims priority to U.S. Provisional Application No. 63/309,574, filed Feb. 13, 2022, which is incorporated herein by reference in its entirety.

### II. BACKGROUND

Hunters, biologists, and others interested in learning about wildlife often deploy trail cameras (aka “game cameras,” “camera traps,” “hunting cameras,” etc.) to obtain pictures of wild animals. Most trail cameras use a single motion sensor that outputs a yes/no detection signal, which can have certain limitations.

### III. SUMMARY

The claims are directed to trail cameras that allow for flexible control of image capture settings dependent on the sensitivity of one or more motion sensors. For instance, a trail camera is provided with multiple motion sensors that, when configured with different sensitivities, cause the trail camera to capture images according to different settings. Another trail camera is provided that temporarily changes image capture settings when a particular motion sensor is triggered.

### IV. BRIEF DESCRIPTION OF THE DRAWINGS

FIG. 1 is a diagram of a trail camera consistent with certain embodiments of the inventive concepts discussed herein.

FIG. 2 is a block diagram of certain components of a trail camera consistent with certain embodiments of the inventive concepts discussed herein.

FIG. 3 is a flow chart of a method consistent with certain embodiments of the inventive concepts discussed herein.

FIG. 4 is a flow chart of a method consistent with certain embodiments of the inventive concepts discussed herein.

FIG. 5 is a block diagram of a system consistent with certain embodiments of the inventive concepts discussed herein.

### V. DETAILED DESCRIPTION

Some trail cameras have a single motion sensor with adjustable sensitivity. When in a high sensitivity setting, the motion sensor can have a greater detection range, but is more susceptible to false triggers—e.g., from moving vegetation, instead of a nearby animal. In a low sensitivity setting, false triggers are reduced, but so is the detection range.

The disclosed implementations offer techniques for using motion sensors with different sensitivities to perform different actions, e.g., capturing still images (pictures) when a higher-sensitivity motion sensor triggers, and capturing videos when a lower-sensitivity motion sensor triggers. In further implementations, motion sensor triggers by the low-sensitivity motion sensor are used to not only cause the trail camera to capture images, but also to adjust settings of the trail camera for a period of time after the trigger. Generally speaking, the two motion sensors can be positioned on the trail camera so that they both have detection zones that can capture animals within a field of view of a (in some cases, single) lens/image sensor of the trail camera.

In some implementations, both motion sensors can have a similar detection angle (e.g., overlapping angle of 75% or more) when configured with the same sensitivity, for instance by aligning the motion sensors vertically or horizontally along the front of the housing, or otherwise positioning/calibrating the motion sensors to have similar view angles. Thus, both motion sensors can capture animals in similar areas, and the same lens and image sensor (e.g., CMOS) can be used to capture images when triggered by either sensor. Note that the range of the motion sensors can be a function of sensitivity. Also, note that in some implementations the first motion sensor can have a wider detection angle than the second motion sensor.

### Example Trail Camera

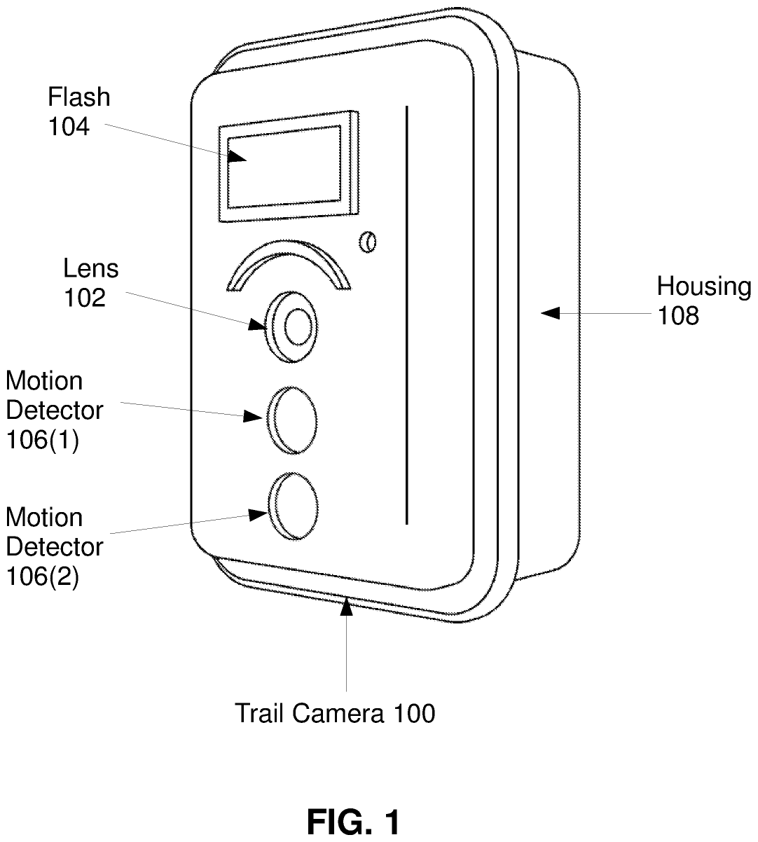

FIG. 1 illustrates an exemplary trail camera 100 consistent with certain embodiments of the present inventive concepts. Trail camera 100 can include a lens 102, flash 104, a first motion sensor 106(1), and a second motion sensor 106(2) embodied in a housing 108. Generally, the motion sensors can be configured to detect movement (e.g., of animals) within a field of view of the trail camera. When motion is detected, the motion sensors can be used to trigger the trail camera to capture images (still pictures or video) via lens 102 having a corresponding image sensor. In some implementations, each motion sensor includes a pyroelectric sensor and circuitry that outputs a signal to the controller indicating that the motion sensor has triggered. This can cause the controller to take a picture or video. The pyroelectric sensors can be activated based on a temperature gradient, such as can be produced by a moving animal. Each motion sensor may have an adjustable sensitivity setting that determines how much of a gradient is sufficient to trigger the motion sensor (and/or adjustable amplifier gain) to cause the controller to take a picture/video. Other implementations may use other motion detection techniques such as acoustic, radar, etc. The motion sensors can have different sensitivities, e.g., fixed sensitivities or adjusted by the controller to different sensitivities.

When taking pictures at night or otherwise in conditions with little ambient light, flash 104 can be used to illuminate the field of view. Trail camera 100 can be embodied in various different forms, as shown in the following U.S. patent References: U.S. Patent Publication Nos. 2013/0010109 to Chen (application Ser. No. 13/425,854), 2011/0150450 to Schnell (application Ser. No. 13/005,701), and 2002/0159770 to Moultrie (application Ser. No. 09/845,641), each of which is incorporated by reference herein in its entirety. The controller may also adjust the intensity of visible or infra-red light produced by the flash when taking nighttime pictures/video.

### Example Trail Camera Components

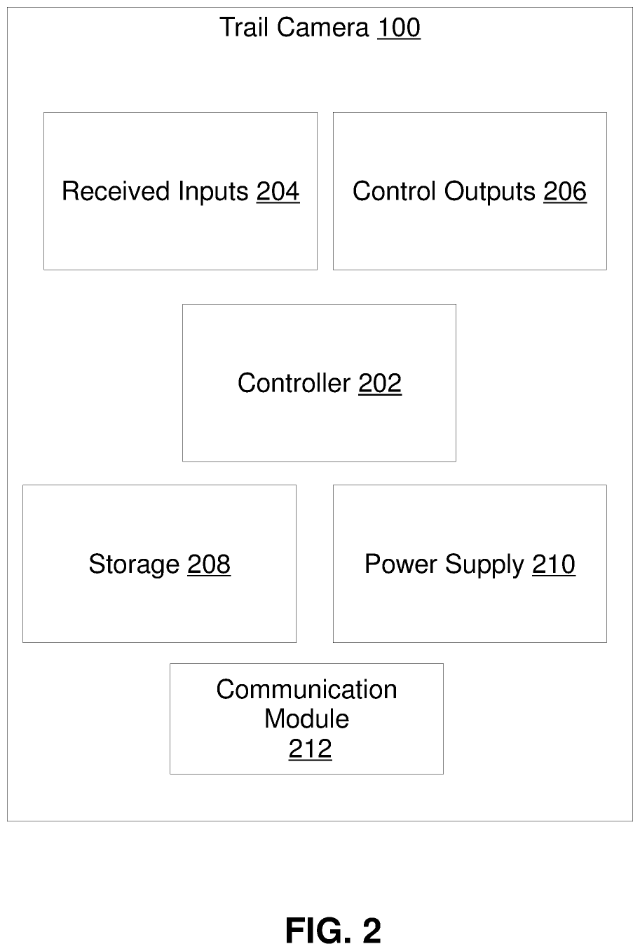

FIG. 2 illustrates a logical view of certain internal components of trail camera 100, e.g., as can be contained within housing 108. The trail camera can include a controller 202 that receives inputs 204 from various components of the camera (e.g., the motion sensor, user interface mechanisms, etc.) and can also provide control outputs 206 to components of the camera (e.g., triggering the flash, a shutter, etc.). Image storage 208 can be used to store images (e.g., digital images and video) captured by the trail camera. Note that, for the purposes of this document, the term “picture” implies a still digital photograph, whereas the term “image” implies either a still digital photograph or a frame (e.g., an I-frame) of a digital video. The trail camera can also include power supply 210 (e.g., batteries) that can provide power to the various components of the trail camera. Note that the motion sensor may have a separate power supply from the controller (e.g., each can be powered by separate batteries). The trail camera can also include a communication module 212, which can perform wired (e.g., USB) or wireless (e.g., Bluetooth, cellular, satellite, or Wi-Fi) communication with one or more other devices, such as a server, a laptop, a mobile phone, a tablet, etc.

In some embodiments, the controller can include a standard computer processing device (e.g., CPU) with an associated memory/storage device and instructions (e.g., as would be found in a laptop or other consumer computing device). In other cases, due to power constraints, the controller can include a power-conserving processing device that can be activated when needed by inputs from the motion sensors that trigger the controller to start performing processing such as adjusting settings as discussed herein. In other words, instead of running the processor full time, the processor can run various tasks such as making setting adjustments, etc., when “awakened” by a trigger from one of the motion sensors and then go back to sleep until triggered again. In addition/alternatively, a local clock can be used to periodically awaken the processor to perform these functions. In either case, the processing device can be configured with logic (e.g., computer-readable instructions, logic gates, etc.) that causes the trail camera to perform certain techniques as set forth further herein. Note that some implementations may also use one or more dedicated electronic circuits, e.g., FPGAs, ASICs, etc., instead of programmable processors, to implement the controller.

### Trail Camera Modes

In some embodiments, the controller is configured to provide both a time-lapse only mode and a triggering mode. In the time-lapse only mode, the trail camera gathers pictures/video at preset intervals irrespective of whether the motion sensor triggers, and indeed the motion sensor may be turned off in this mode. For example, in time lapse only mode, the trail camera can be configured to take a single picture (or multiple pictures or one or more videos) at regular intervals such as every minute, every 5 minutes, etc. In the triggering mode, the trail camera takes a picture (or multiple pictures/video) when the motion sensor triggers the controller to do so. Some implementations also provide a concurrent time lapse and triggering mode. With concurrent time lapse and triggering mode, the camera takes pictures/video at specified regular intervals but also takes pictures/video when triggered by one or both of the motion sensors. The term “time-lapse” mode as used herein refers to either time-lapse only mode or concurrent time-lapse and triggering mode.

In further embodiments, the controller is configured to switch between a video mode and a picture mode. Generally speaking, in video mode, the controller may cause the trail camera to store videos, e.g., in video formats such as .avi. In picture mode, the controller is configured to take individual pictures such as in a .jpeg format. Picture mode may have user-configurable burst settings to take a certain number of pictures for each activation of the motion sensor or “trigger” (e.g., 1, 3, or 6 pictures) whereas video mode may have user-configurable video length settings (e.g., 5, 10, or 15 seconds).

Note that the camera can be in various combinations of time-lapse/triggering and video/picture modes. For example, time-lapse mode can allow for the following combinations of picture/video modes—time-lapse single picture mode (e.g., take a single picture every minute), time lapse burst mode (e.g., take 3 pictures at one second intervals every minute), and time lapse video mode (e.g., take a 5 second video every minute). Likewise, triggering mode can allow for the following combinations of picture/video modes—triggering single picture mode (e.g., take a single picture when triggered by the motion sensor), triggering burst mode (e.g., take 3 pictures at one second intervals when triggered by the motion sensor), and triggering video mode (e.g., take a 5 second video when triggered by the motion sensor).

In some implementations, the controller may adjust the number of pictures taken per trigger, e.g., from 1 to 3, 3 to 6, or 6 to 3, 3 to 1, etc. In further implementations, the controller may adjust the length of videos taken per trigger. In addition, the controller may adjust the resolution of pictures/video taken to higher/lower resolutions. Furthermore, the controller can change the frame rate of videos under various circumstances, and can also adjust flash intensity when taking pictures at night or other dark conditions.

### First Example Method

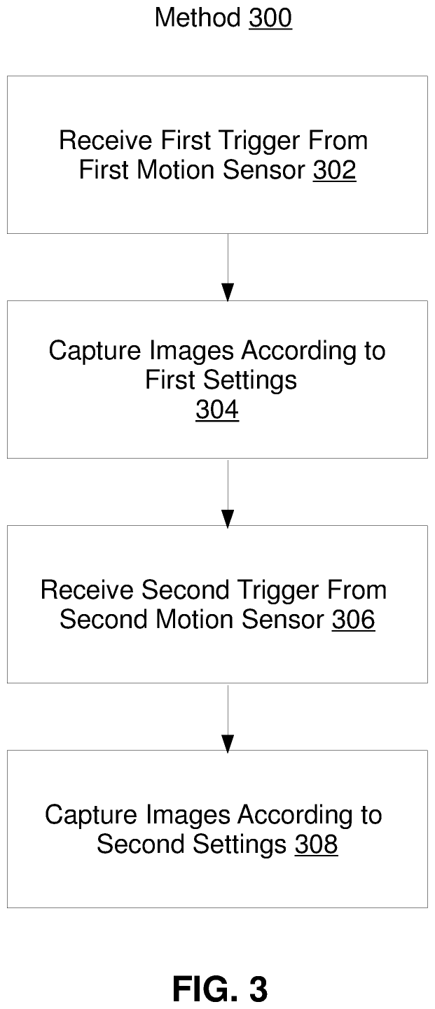

FIG. 3 illustrates an exemplary method 300 for controlling a trail camera. In some embodiments, method 300 can be performed directly by trail camera 100. In some cases, another device (mobile phone, tablet, laptop, etc.) in communication with trail camera 100 can configure various settings that the trail camera employs when performing method 300, as discussed more below.

Method 300 begins at block 302, where the controller receives a first trigger from a first motion sensor when the first motion sensor is configured with a first motion sensor sensitivity.

Method 300 continues at block 304, where the trail camera captures images according to first trail camera settings in response to the first trigger.

Method 300 continues at block 306, where the controller receives a second trigger from a second motion sensor when the second motion sensor is configured with a second motion sensor sensitivity.

Method 300 continues at block 308, where the trail camera captures images according to second trail camera settings. in response to the second trigger.

Method 300 can be performed continuously by the trail camera.

At least one of the second trail camera settings can be different than the first trail camera settings. For example, the first and second trail camera settings can be associated with respective first and second configurations, e.g., specified by user input or as default configurations stored on the trail camera during manufacture. In addition, the motion sensor sensitivities can be different (e.g., low sensitivity for the second motion sensor and high sensitivity for the first).

### Example Trail Camera Settings

In some cases, the first and second motion sensor sensitivities are preconfigured during manufacture. They can be static or user-adjustable, e.g., via a user interface mechanism on the trail camera or via an application on a mobile device. When the second motion sensor has a lower sensitivity than the first motion sensor, triggers by the second motion sensor generally convey greater confidence that the trigger is indeed caused by an animal as opposed to a false trigger caused by moving vegetation or other inanimate objects, and also can indicate that the animal is relatively close to the trail camera.

Some implementations can capture more images when triggered by the second motion sensor (e.g., 3) than by the first motion sensor (e.g., 1). This generally will cause the trail camera to capture more images of animals that are closer to the camera and also can reduce the number of images taken for false triggers, since the first motion sensor is more likely to have false triggers given the higher sensitivity. Some implementations, however, may take more pictures when triggered by the first motion sensor (e.g. 3) than the second motion sensor, for instance, due to user preference.

Some implementations can capture videos when triggered by the second motion sensor and one or more still pictures for each trigger by the first motion sensor. This generally will cause the trail camera to capture videos of animals that are closer to the camera and also can reduce the number of videos taken for false triggers, since the first motion sensor is more likely to have false triggers given the higher sensitivity. Some implementations, however, may take one or more videos when triggered by the first motion sensor and one or more still images when triggered by the second motion sensor, for instance, due to user preference.

Some implementations can capture pictures or videos at relatively high resolution (e.g., 20 megapixels) when triggered by the second motion sensor and pictures or videos at a lower resolution (e.g., 5 megapixels) when triggered by the first motion sensor. This generally will cause the trail camera to capture higher resolution images of animals that are closer to the camera. Some implementations, however, may use higher resolution when triggered by the first motion sensor and lower resolution when triggered by the second motion sensor, for instance, due to user preference. This may be particularly useful because animals further from the trail camera may be easier to see at higher image resolutions, whereas lower resolutions may be adequate for animals closer to the trail camera.

Some implementations can capture videos of a first length (e.g., 30 seconds) and/or a higher frame rate (e.g., 30 fps) when triggered by the second motion sensor and of a second length (e.g., 10 seconds) or lower frame rate (e.g. 15 fps) when triggered by the first motion sensor. This generally will cause the trail camera to capture longer videos of animals that are closer to the camera. Some implementations, however, may use longer videos/higher frame rates when triggered by the first motion sensor and shorter videos/lower frame rates when triggered by the second motion sensor, for instance, due to user preference.

At night or in dark conditions, some implementations can use a lower flash intensity (e.g., fewer lumens of visible light, lower wattage of IR light) when triggered by the second motion sensor and a higher flash intensity when triggered by the first motion sensor. This generally allows the trail camera to use lower intensity flash for animals closer to the trail camera, since less illumination is necessary for animals closer to the lens/image sensor. Again, this can be a function of user settings and users can choose to use lower flash intensity for the first motion sensor instead, e.g., to conserve battery power.

Some implementations can cause the trail camera to enter time lapse only mode or concurrent time lapse and triggering mode (e.g., for a user-specified or predefined period of time) when triggered by the second motion sensor, but not the first motion sensor, or to temporarily enter either time lapse mode after triggers by either motion sensor, but for longer periods of time for triggers by the second motion sensor. Some implementations can also use different exposure times depending on which motion sensor is triggered, e.g., potentially longer exposure times could be useful at night for the first motion sensor than the second motion sensor since animals may be further away. One way to accomplish different flash intensities and exposure settings is to use different exposure tables for different motion sensors, with each exposure table having exposure times and flash intensities calibrated for the respective motion sensor sensitivities of the different motion sensors.

Note that the functionality described above for dual motion sensors can be extended to additional motion sensors with different sensitivities. For instance, given three motion sensors set to high, medium, and low sensitivity, each motion sensor can be used to capture different numbers of pictures per trigger, different length videos, different frame rates, different flash intensities, different resolutions, etc.

In addition, some implementations employ a single motion sensor that outputs an indicator of the magnitude of a given trigger, e.g., the strength of the gradient. For instance, a motion sensor that asserts a first pin for low-magnitude triggers and a second pin for high-magnitude triggers can be employed. All of the functionality described above and below for triggers by the first motion sensor can be performed when the first pin is asserted, and all of the functionality described above and below for triggers by the second motion sensor can be performed when the second pin is asserted.

In further implementations, a single motion sensor outputs a bit representation of the magnitude of a given trigger (e.g., 32 bit integer, floating point, etc.) The controller can use fixed or user-adjustable thresholds to define a low-magnitude trigger and a high-magnitude trigger. Triggers that exceed the high-magnitude threshold can be treated as described above for triggers from the second motion sensor, and triggers that exceed the low-magnitude threshold but not the high-magnitude threshold can be treated as described above for triggers from the first motion sensor.

In some cases, trail camera settings can be combined, e.g., based on user input or predefined settings. For instance, the first motion sensor can capture low-resolution pictures without entering either time lapse mode, and the second motion sensor can capture high-resolution videos and temporarily enter either time lapse mode. As another example, the first motion sensor can be used to capture different numbers of pictures (more or less) than the second motion sensor, at different (higher or lower) resolution than the pictures captured by the second motion sensor. For instance, the first motion sensor could be used to capture a single high-resolution picture for every trigger, and the second motion sensor could be used to capture a three-picture burst of lower-resolution pictures. As another example, the first motion sensor can be used to capture different length videos (longer or shorter) than the second motion sensor, at different (higher or lower) resolution and/or a different frame rate (higher or lower) than the videos captured by the second motion sensor. For instance, the first motion sensor could be used to capture a 10 second high-resolution video at 24 fps for every trigger, and the second motion sensor could be used to capture a thirty second low-resolution video at 15 fps for every trigger. In any of the above examples of combined settings, the second motion sensor can be used to initiate one of the time lapse modes. In other cases, time lapse can be initiated for triggers by either motion sensor in addition to any of the previous combined settings, with relatively shorter time lapse intervals (e.g., 30 seconds) when triggered by the second motion sensor and longer intervals (e.g., one minute) when triggered by the first motion sensor.

### Second Example Method

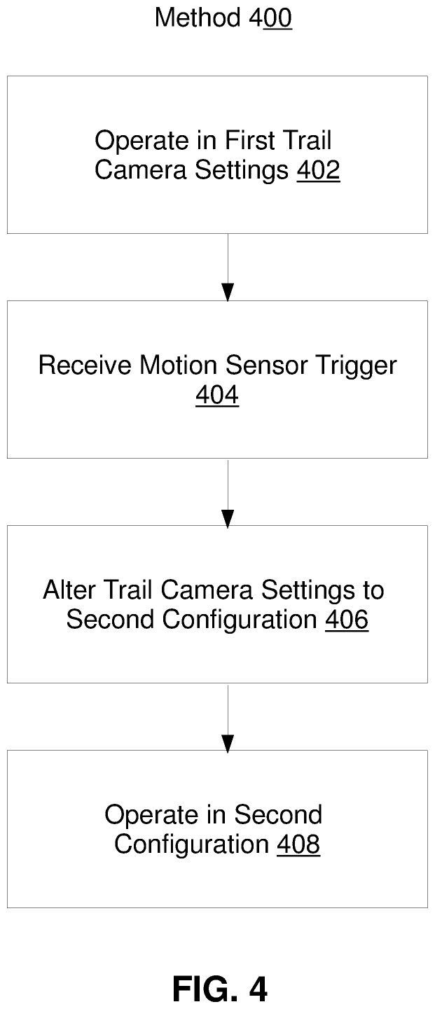

FIG. 4 illustrates an exemplary method 400 for controlling a trail camera. In some embodiments, method 400 can be performed directly by trail camera 100. In some cases, another device (mobile phone, tablet, laptop, etc.) in communication with trail camera 100 can configure various settings that the trail camera employs when performing method 400, as discussed more below.

Method 400 begins at block 402, where the trail camera operates according to first trail camera settings. For example, the first trail camera settings can be associated with a first configuration, e.g., specified by user input or as a first default configuration that is stored on the trail camera (e.g., on a local PROM, flash memory, or other non-volatile storage).

Method 400 continues at block 404, where a motion sensor trigger from the second motion sensor is detected.

Method 400 continues at block 406, where, in response to the motion sensor trigger from the second motion sensor, the trail camera configuration is altered (e.g., by the controller) to temporarily operate according to second trail camera settings, at least one of which is different than the first trail camera settings. For example, second first trail camera settings can be associated with a second configuration, e.g., specified by user input or as a second default configuration stored on the trail camera.

Method 400 continues at block 408, where the trail camera operates according to the second trail camera settings.

The first configuration can include one or more first trail camera settings and the second configuration can include one or more second trail camera settings. The first and second trail camera settings can have different values for least one of time lapse functionality, triggering functionality, motion sensor sensitivity, flash intensity, picture/video mode functionality, number of pictures taken per trigger, length of videos, and/or image resolution of the trail camera. In addition, the motion sensor sensitivities can be different (e.g., low sensitivity for the second motion sensor and high sensitivity for the first).

Note that method 400 can be performed continuously over time with multiple changes to settings. For example, blocks 402-408 can be performed multiple times after the trail camera is deployed. In some cases, method 400 can revert from block 408 to block 402 after a specified amount of time has passed after receiving the trigger from the second motion sensor. In other words, the trail camera can normally operate according to the first trail camera settings, and can transition to the second trail camera settings for a specified amount of time after each trigger by the second motion sensor. Once a specified amount of time (e.g., five minutes) has passed since the last trigger by the second motion sensor, the trail camera can revert to the first trail camera settings until another trigger by the second motion sensor. The specified amount of time can be stored on the trail camera persistently on the non-volatile storage, or can be provided by user input (e.g., from a separate device or via an input mechanism on the trail camera)

### Motion Sensor Control of Camera Settings

As discussed above and in more detail below, the trail camera can be configured by the controller to selectively alter certain settings based on motion sensor triggers. For example, the controller can perform any of the following adjustments based on a motion sensor trigger: transition between time lapse mode and triggering (picture or video) mode, adjust picture mode to increase/decrease number of pictures taken or adjust the lengths of video taken in video mode, adjust picture/video resolution, adjust motion sensor sensitivity, and/or adjust flash intensity.

The following example illustrates how using a second motion sensor to control trail camera settings can be useful. Assume a conventional trail camera is deployed with a single motion sensor in a high sensitivity setting and configured to capture videos. On a windy day with numerous false triggers, the trail camera might capture numerous videos of moving vegetation with no animals present. The user might return and, seeing the videos that lack animals, decide to reduce their motion sensor sensitivity to low. This may reduce the number of false triggers, but can also result in the trail camera failing to trigger when animals are in proximity to the trail camera.

Now, assume trail camera 100 is deployed with motion sensor 106(1) in a high sensitivity setting and motion sensor 106(2) in a low sensitivity setting. Further, assume that the first trail camera settings specify capturing pictures, and the second trail camera settings specify capturing videos. Most users would probably prefer not to have any false triggers at all, but if there is a false trigger, users would likely prefer to only “waste” a static picture on a false trigger instead of taking a video for a false trigger.

If a false trigger occurs while the camera is in the first configuration, the camera will capture a picture. Only once the second motion sensor triggers does the camera begin capturing video. The effect is that the camera tends to take videos only once a strong movement signal is detected by the camera. Since a signal large enough to cause a trigger by the second motion sensor is very likely to be an animal, it is likely that triggers by either motion sensor shortly thereafter will also be caused by the same animal or another animal that is with the animal that first triggered the second motion sensor. In other words, even triggers by the higher-sensitivity first motion sensor are less likely to be false triggers once the second motion sensor has triggered. Thus, by temporarily switching to video mode after the low-sensitivity motion sensor is triggered, videos captured in response to triggers by either motion sensor are relatively more likely to have animals present in the videos.

As another example, assume the first trail camera settings specify capturing one image per trigger, whereas the second trail camera settings specify capturing three images per trigger. Again, most users would probably prefer not to have any false triggers at all, but if there is a false trigger, users would likely prefer to only “waste” a single picture on a false trigger instead of taking a three-picture burst for a false trigger. If a false trigger occurs while the camera is in the first configuration, the camera will capture a single picture. Only once the second motion sensor triggers does the camera begin capturing three-picture bursts when triggered by either motion sensor. The effect is that the camera tends to take bursts only once a strong movement signal is detected by the camera. Thus, by temporarily switching to burst mode after the low-sensitivity motion sensor is triggered, image bursts captured in response to triggers by either motion sensor are relatively more likely to have animals present in the videos.

More generally, triggers by the second motion sensor can be used as an indicator of confidence that an animal is nearby the trail camera. Thus, the controller can cause the trail camera to take various actions to extract more information from the environment after the second motion sensor triggers. For instance, after a trigger by the second motion sensor, the controller can temporarily increase picture/video resolution for images captured in response to triggers by either or both motion sensors. Likewise, after a trigger by the second motion sensor, the controller can temporarily increase the length of videos captured in response to triggers by either or both motion sensors. With respect to videos, some implementations can also temporarily use higher frame rates after triggers by the second motion sensor, for videos captured using either motion sensor.

With respect to time lapse, after a trigger by the second motion sensor, the controller can temporarily entire time lapse only or concurrent time lapse and triggering mode. Alternatively, if the trail camera is already in concurrent time lapse and triggering mode, the controller can temporarily shorten time lapse intervals in response to triggers by the second motion sensor (e.g., from one minute to 30 seconds).

In further implementations, the sensitivity of either motion sensor can be adjusted in response to a trigger by the second motion sensor. For instance, if the second motion sensor is in a low sensitivity setting and the first motion sensor in a medium sensitivity setting, the controller can temporarily set the first motion sensor to a high sensitivity setting after a trigger by the second motion sensor.

In further implementations, flash intensity and/or exposure time can be temporarily increased or decreased in response to a trigger by the second motion sensor. For instance, the second motion sensor being triggered can imply an animal is relatively close to the trail camera, so it may be useful to temporarily use a lower flash intensity or shorter exposure time for triggers by the first motion sensor and the second motion sensor. One way to accomplish this is to temporarily use a different exposure table after a trigger by the second motion sensor.

In a similar manner to that described previously, a single motion sensor that outputs an indicator of the magnitude of a given trigger can be employed. For instance, a motion sensor that asserts a first pin for low-magnitude triggers and a second pin for high-magnitude triggers can be employed. All of the functionality described above and below for triggers by the first motion sensor can be performed when the first pin is asserted, and all of the functionality described above and below for triggers by the second motion sensor can be performed when the second pin is asserted.

In further implementations, a single motion sensor outputs a bit representation of the magnitude of a given trigger (e.g., 32 bit integer, floating point, etc.) The controller can use fixed or user-adjustable thresholds to define a low-magnitude trigger and a high-magnitude trigger. Triggers that exceed the high-magnitude threshold can be treated as described above for triggers from the second motion sensor, and triggers that exceed the low-magnitude threshold but not the high-magnitude threshold can be treated as described above for triggers from the first motion sensor.

In some cases, trail camera settings can be combined, e.g., based on user input or predefined settings. For instance, low-resolution static pictures can be captured without entering either time lapse mode prior to triggering of the second motion sensor, and, once the second motion sensor triggers, the trail camera can temporarily capture high-resolution videos and temporarily enter either time lapse mode. As another example, the controller can cause the trail camera to temporarily increase resolution of images or videos and temporarily enter either time lapse mode after a trigger by the second motion sensor. As another example, the controller can cause the trail camera to temporarily change (increase or decrease) the number of pictures taken in response to triggers by either motion sensor, and temporarily increase or decrease the resolution of the pictures. For instance, the trail camera could normally capture a single low-resolution picture for every trigger by the first motion sensor, and, after a trigger by the second motion sensor, temporarily capture three-picture bursts of higher-resolution pictures in response to triggers by either motion sensor. As another example, the trail camera can normally capture videos of a specified length, resolution, and/or frame rate in response to triggers by the first motion sensor. After a trigger by the second motion sensor, the trail camera can increase or decrease the length, resolution, and/or frame rate of videos captured in response to triggers by either motion sensor.

In any of the above examples of combined settings, the second motion sensor can be used to temporarily initiate one of the time lapse modes, or to temporarily shorten time lapse intervals (e.g., from one minute to 30 seconds). Note that the discussion of time lapse above can refer to time lapse capture of single images, burst images, or videos.

### Example System

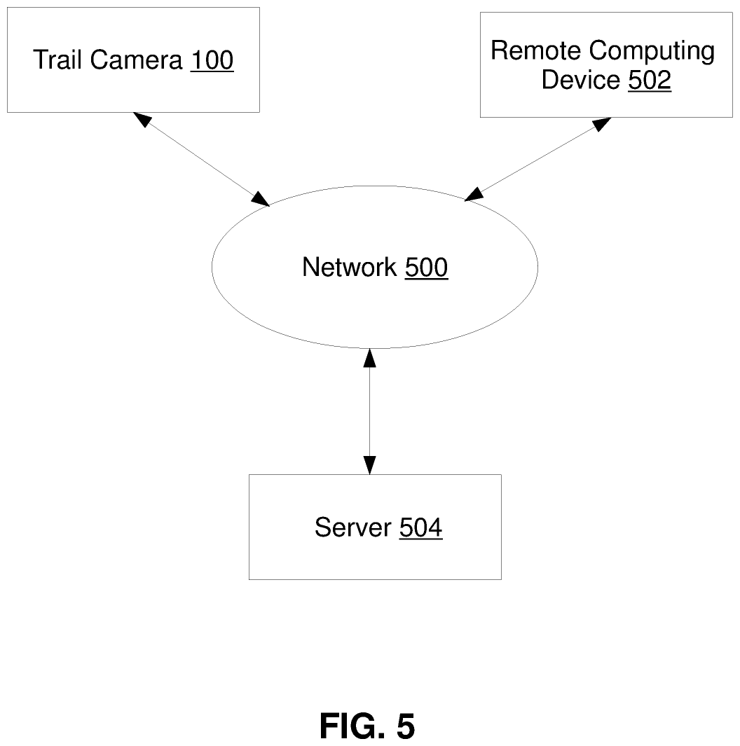

FIG. 5 illustrates an exemplary system of devices including a trail camera 100, remote computing device 502, and server 505 connected to a wired and/or wireless network 500. In some implementations, remote computing device 502 can control trail camera 100 over network 500. In some implementations, either remote computing device 502 or trail camera 100 can access server 505 and control the trail camera based on information obtained therefrom.

In some implementations, the trail camera also includes a communication component (e.g., a wireless transceiver) configured to communicate via Wi-Fi, 3G/5G, Bluetooth, or other wireless communication technologies to access remote devices such as remote computing device 502 (e.g., short-range wireless with a local user's smart phone, tablet, laptop, etc.) and/or a server over the Internet. The trail camera can also include an internal location module (e.g., GPS, cellular triangulation, etc.) configured to obtain a location of the trail camera, or else receive a location from a local user device.

### User Inputs

The trail camera can have various user input mechanisms (e.g., buttons, switches, dials, number/letter pad, touch screen, etc.) to configure any of the settings described above. Alternatively or in addition, the trail camera can receive configuration instructions over a wide or local area network, or via a direct wired or wireless connection (USB, Bluetooth, Wi-Fi direct). The user input mechanisms or configuration instructions can specify first and second trail camera settings for any of the scenarios described above. For instance, the user input mechanisms or configuration instructions can specify first and second settings for least one of time lapse functionality, triggering functionality, motion sensor sensitivity, flash intensity, picture/video mode functionality, number of pictures taken per trigger, length of videos, video frame rate, exposure time, and/or image resolution of the trail camera. A user device such as a mobile phone, tablet, or laptop can display a user interface with graphical options for configuring the first and second trail camera settings and other information and sending configuration instructions identifying the settings to the trail camera, as described more below.

For instance, in implementations where the trail camera is configured to perform method 300, the input mechanisms on the trail camera or the configuration instructions received by the trail camera can specify first trail camera settings to use when triggered by the first motion sensor, sensitivity of the first motion sensor, second trail camera settings to use when triggered by the second motion sensor, and sensitivity of the second motion sensor.

In implementations where the trail camera is configured to perform method 400, the input mechanisms on the trail camera or the configuration instructions received by the trail camera can specify first and second motion sensor sensitivity, the amount of time to temporarily use the second trail camera settings after a trigger by the second motion sensor (e.g., 5 minutes), the first motion sensor settings (which can be used normally) and the second motion sensor settings (used temporarily after a trigger by the lower-sensitivity motion sensor).

Some implementations may offer the user the ability to use different settings at different times of day. For instance, the input mechanisms on the trail camera or the configuration instructions received by the trail camera can specify first and/or second trail camera settings for different times of day. Any of the above-mentioned settings can be used at different times. For instance, the user could specify that the first trail camera settings involve taking low-resolution images at night and high resolution videos during the day, and the second trail camera settings involve taking low-resolution video at night and high resolution video during the day (for either method 300 or 400).

In some cases, the user can specify the actual time of day to use certain settings, e.g., from 10 AM until 2 PM, use one group of first and second trail camera settings and at other times use a second group of first and trail camera settings. In other implementations, the user can specify separate night and daytime settings, and the controller may configured to adaptively change the times of day at which the first and second groups of settings are used based on sunset and sunrise, e.g., effectively as a window of time that moves as sunrise/sunset times change from day to day.

Thus, the user may be able to configure the trail camera to start using a first group of first/second settings at 30 minutes before sunrise and transition to a second group of first/second settings one hour after sunrise, for 90 minutes of the first group each morning and the rest of the time using the second group. The controller may adjust the time of day at which to use each group based on a sunrise/sunset table to follow changes in the sunrise. The controller may take similar actions for sunset. Similarly, the durations for sunset are not necessarily the same as for sunrise, e.g., the user could configure the controller to use the first group of settings 45 minutes before sunset and go back to the second group of settings minutes after sunset.

Thus, for instance, the input mechanisms on the trail camera or the configuration instructions received by the trail camera can specify the following:
(1) a first group of settings to use within a 2 hour window centered at dawn or dusk, including first trail camera settings and second trail camera settings.
(2) a second group of settings to use at other times, with different first trail camera settings and/or different second trail camera settings than (1).

As one example, the user might wish to capture more images near dawn/dusk than at other times. Thus, the user might specify that the first trail camera settings for (1) include a three image burst and the second trail camera settings for (1) include a six image burst, while the first trail camera settings for (2) include a single image capture and the second trail camera settings for (2) include a three-image burst.

Or the user may wish to capture video only at dawn or dusk, so the user might specify that the first trail camera settings for (1) include 10 second video and the second trail camera settings for (1) include 30 second video, while the first trail camera settings for (2) include a single image capture and the second trail camera settings for (2) include a three-image burst.

Or the user might specify that the first trail camera settings for (1) include 10 second video and the second trail camera settings for (1) include 30 second video, while the first trail camera settings for (2) include a single image capture and the second trail camera settings for (2) include a 10 second video. In this way, the trail camera would capture video for any trigger at dawn and dusk, but would only capture video for strong triggers at other times.

Either time lapse mode can be configured to be temporarily initiated for triggers by the second motion sensor. For instance, users might configure the trail camera so that time lapse is performed only for second motion sensor triggers in (1), so that the second motion sensor does not initiate time lapse functionality at other times of day. This can be performed in combination with adjusting picture/video settings as described above, e.g., in paragraphs 0065 and 0066. Alternatively, the second motion sensor can be used to temporarily shorten time lapse intervals. As another example, the second motion sensor can cause temporary time lapse mode in either (1) or (2), with shorter time lapse intervals in (1) than in (2) and/or for longer periods of time in (1) than in (2). This allows the user to set the trail camera for more aggressive temporary time lapse capture around dusk and dawn, while still using time lapse temporarily to some extent after triggers by the second motion sensor. Again, can be performed in combination with adjusting picture/video settings as described above, e.g., in paragraphs 0065 and 0066

Note that the aforementioned examples are not limiting and that any of the various combinations of first and trail camera settings described above can be user-configured for different times of day. Thus, the user has the flexibility to fully control how the trail camera operates when triggered by different motion sensors (method 300) or how the trail camera operates normally vs after a trigger by the lower-sensitivity second motion sensor (method 400).

1. A trail camera comprising:
a lens;
a first motion sensor;
a second motion sensor;
a flash; and
a controller configured to:
when triggered by the first motion sensor when the first motion sensor is configured with a first motion sensor sensitivity, cause the trail camera to capture images according to first trail camera settings; and
when triggered by the second motion sensor when the second motion sensor is configured with a second motion sensor sensitivity, cause the trail camera to capture images according to second trail camera settings,
wherein the first motion sensor sensitivity is different than the second motion sensor sensitivity, and
wherein the first trail camera settings and the second trail camera settings have different values to control image capture by the trail camera.

2. The trail camera of claim 1, wherein the first trail camera settings and the second trail camera settings have different values for least one of time lapse functionality, triggering functionality, motion sensor sensitivity, flash intensity, picture/video mode functionality, number of pictures taken per trigger, length of videos, video frame rate, exposure time, and/or image resolution of the trail camera.

3. The trail camera of claim 2, wherein the first motion sensor has a relatively higher motion sensor sensitivity than the second motion sensor.

4. The trail camera of claim 3, wherein the controller is configured to:
cause the trail camera to capture a first number of images when triggered by the first motion sensor; and
cause the trail camera to capture a second number of images, greater than the first number, when triggered by the second motion sensor.

5. The trail camera of claim 3, wherein the controller is configured to:
cause the trail camera to capture pictures when triggered by the first motion sensor; and
cause the trail camera to capture videos when triggered by the second motion sensor.

6. The trail camera of claim 3, wherein the controller is configured to:
cause the trail camera to capture images or video at a first image resolution when triggered by the first motion sensor; and
cause the trail camera to capture images or video at a second image resolution when triggered by the second motion sensor.

7. The trail camera of claim 3, wherein the controller is configured to:
cause the trail camera to capture videos of a first length when triggered by the first motion sensor; and
cause the trail camera to capture videos of a second length, greater than the first length, when triggered by the second motion sensor.

8. The trail camera of claim 1, wherein the controller is configured to:
cause the trail camera to temporarily enter time lapse mode or concurrent time lapse and triggering mode when triggered by the second motion sensor; or
cause the trail camera to temporarily shorten time lapse intervals when triggered by the second motion sensor.

9. A trail camera comprising:
a lens;
a first motion sensor;
a second motion sensor;
a flash; and
a controller configured to:
operate the trail camera according to first trail camera settings;
receive a trigger from the second motion sensor;
responsive to receiving the trigger from the second motion sensor, temporarily operate the trail camera according to second trail camera settings,
wherein the first trail camera settings and the second trail camera settings have different values to control image capture by the trail camera.

10. The trail camera of claim 9, wherein the first trail camera settings and the second trail camera settings have different values for least one of time lapse functionality, triggering functionality, motion sensor sensitivity, flash intensity, picture/video mode functionality, number of pictures taken per trigger, length of videos, and/or image resolution of the trail camera.

11. The trail camera of claim 10, wherein the first motion sensor has a relatively higher motion sensor sensitivity than the second motion sensor.

12. The trail camera of claim 11, wherein the controller is configured to:
prior to receiving the trigger from the second motion sensor, capture a first number of images per trigger from the first motion sensor; and
after receiving the trigger from the second motion sensor, temporarily capture a second number of images, greater than the first number, per trigger from the first motion sensor.

13. The trail camera of claim 11, wherein the controller is configured to:
prior to receiving the trigger from the second motion sensor, capture one or more pictures per trigger received from the first motion sensor; and
after receiving the trigger from the second motion sensor, temporarily capture one or more videos per trigger received from the first motion sensor.

14. The trail camera of claim 11, wherein the controller is configured to:
prior to receiving the trigger from the second motion sensor, capture images or video at a first image resolution when triggers are received from the first motion sensor; and
after receiving the trigger from the second motion sensor, temporarily capture images or video at a second image resolution that is higher than the first image resolution when further triggers are received from the first motion sensor.

15. The trail camera of claim 11, wherein the controller is configured to:
prior to receiving the trigger from the second motion sensor, capture videos of a first length when triggers are received from the first motion sensor; and
after receiving the trigger from the second motion sensor, capture videos of a second length that is greater than the first length when further triggers are received from the first motion sensor.

16. The trail camera of claim 11, wherein the controller is configured to:
prior to receiving the trigger from the second motion sensor, operate the trail camera without time lapse functionality; and
after receiving the trigger from the second motion sensor, enter time lapse mode or concurrent time lapse and triggering mode.

17. The trail camera of claim 11, wherein the controller is configured to increase or decrease sensitivity of the first motion sensor responsive to the trigger by the second motion sensor, or shorten time lapse intervals responsive to the trigger by the second motion sensor.

18. The trail camera of claim 11, wherein the controller is configured to disable the first motion sensor or ignore triggers from the first motion sensor for a specified period of time after receiving the trigger from the second motion sensor.

19. The trail camera of claim 18, wherein the controller is configured to operate the trail camera according to the second trail camera settings for a specified period of time after receiving the trigger from the second motion sensor, and then revert to the first trail camera settings.

20. The trail camera of claim 19, wherein the controller is configured to receive the specified period of time via user input to a user interface mechanism on the trail camera or by receiving the specified period of time wirelessly from another device.
